(19) United States
(12) Patent Application Publication
(10) Pub. No.: US 2007/0020022 A1
(43) Pub. Date: Jan. 25, 2007

(54) Cosmetic pencil and process for the production thereof

(75) Inventors: Josef Herrmann, Herzogenaurach (DE); Sabine Knapp, Eckental (DE); Gabriel Utan, Uttenreuth (DE)

Correspondence Address: BACHMAN & LAPOINTE, P.C., 900 CHAPEL STREET, SUITE 1201, NEW HAVEN, CT, 06510, US

(73) Assignee: SCHWAN-STABILO COSMETICS GMBH & CO. KG, Heroldsberg (DE)

(21) Appl. No.: 10/547,201

(22) PCT Filed: Apr. 1, 2004
(86) PCT No.: PCT/EP04/03449

§ 371 Date: Oct. 11, 2005

(30) Foreign Application Priority Data
Apr. 4, 2003 (EP) 03007832.3

(51) Int. Cl. B43K 23/00; B43K 5/12

(52) U.S. Cl. 401/88; 401/192

(57) ABSTRACT

A cosmetic pencil which comprises a sleeve body which in its interior has a longitudinally extending cavity which is open outwardly by way of at least one opening, and a lead of a cosmetic material which is arranged in the cavity. It is further provided that the lead is arranged in the sleeve body at least portion-wise in spaced relationship in the peripheral and/or longitudinal direction with respect to the inside wall of the cavity of the sleeve body, forming an empty space.

### BACKGROUND OF THE INVENTION

The invention relates to a cosmetic pencil and a process for the production thereof.

The leads or cartridges used for the cosmetic pencils, comprising a cosmetic material, have hitherto been molded into the sleeve body of the pencil. Molding processes of that kind are sufficiently known from the patent literature. Thus GB patent No 1 538 188 describes in detail how a liquid material can be introduced into a sleeve body comprising a material which can be sharpened to a point. In that case polystyrene or polyethylene are proposed as the material for the sleeve body.

In addition DE patents Nos 27 18 957, 27 59 610, 27 59 856 and 30 28 231 disclose molding processes for cosmetic pencils, with the simultaneous formation of a point on the lead. In that case sleeve bodies of wood or plastic material which can be sharpened to a point are used. DE patents Nos 27 18 957 and 27 59 610 describe how the end portion of a sleeve body can be machined by a cutting procedure in order to prepare the end for an end cap to be fitted thereover.

In addition DE patent No 40 05 894 describes a process for molding cosmetic pencils with a relatively thin lead and with a sleeve body of plastic material, which can be sharpened to a point, using axially movable molding needles, and in that procedure at the same time forming a point thereon. In addition U.S. Pat. No. 1,945,255 describes a process for the production of a cosmetic pencil wherein firstly a sleeve of rolled paper is produced and then it is provided with a sharpenable casing by means of movable needles. The sleeve with materials molten thereon is then filled by axially movable molding needles.

Processes are also known for the production of sleeve bodies for cosmetic pencils by means of injection molding, in which case those sleeves can also comprise clear or transparent materials and can be filled with a cosmetic material which is liquefied by heating. In order later to prevent the molded lead from falling out of the sleeve body or to prevent the lead from also being rotated when the sleeve body is being sharpened, the interior of the sleeve body can be of a conical configuration or can be provided with a cross-section which is different from round. In that respect mention may be made for example of U.S. Pat. Nos. 4,413,921 and 5,957,607, EP No 0 767 616 or DE laid-open application No 101 06 834. It is also known for the inner end region of the cavity present in the sleeve body to be provided with a female screwthread in order reliably to fix therein a lead of cosmetic material which has been molded thereinto. Alternatively one or more annular grooves can also be incorporated into that end portion. It is also known for the end region to be closed with a wax plug of a suitable wax which is molded in place, in a working step which is subsequent to the operation of molding the cosmetic lead material in position, in order to prevent evaporation of volatile constituents out of the lead material.

Mention may also be made of U.S. Pat. No. 5,340,226 describing a process in which a cosmetic material is introduced in the hot condition into a thin-wall tube and then after cooling and solidification of the cosmetic material that tube is fitted into a sleeve body comprising a sharpenable plastic material.

All the processes set forth hereinbefore are therefore based on the notion of molding a previously heated material in the hot liquid condition in a sleeve body which can comprise a sharpenable material such as wood, a foamed plastic material or a molded or extruded plastic material which can be opaque or translucent through to transparent. Opaque plastic materials can be colored therethrough in respect of the material itself and/or can be externally lacquered or printed upon using the same color as the lead or can be designed ‘CI-true’ in the corporate color of the seller. Transparent sleeves have in comparison the advantage that the color of the lead is visible from the outside and therefore lacquering using the same color as the lead is not necessary.

The above-specified molding processes all have a crucial disadvantage when using at least partially transparent sleeve bodies: the heated cosmetic material which is molded in the liquid condition in the transparent sleeve body is of lower density when hot and thus is of a larger volume than subsequently the cooled lead. The material therefore initially adheres to the inside wall of the cavity provided in the sleeve body, but then at least partially becomes detached therefrom again because of the shrinkage process. At the rear end of the lead—when the lead is poured into a perpendicularly arranged sleeve body that is the upper end of the sleeve body—a more or less pronounced pouring cone is generally also formed there. However, where the cosmetic material has become detached from the inside wall of the cavity again, gases which have penetrated thereinto (air or gaseous constituents from the lead) have the result that either places with a silvery gleam occur—due to total reflection—or matt locations occur, due to minimal deposits of the molding material. Both are serious optical deficiencies which are not to be avoided even by variations in the molding process. Heating the sleeves to the molding temperature is not possible in most cases because the thermoplastic materials used can change in shape in the hot condition and because moreover, just due to the cooling times for the cosmetic material which are then increased in length, uncontrollable crystallisation phenomena can occur within that material and therefore the cycle times of the molding machine are also very severely delayed due to the prolonged cooling phases. If the cooling zones of the molding machine were increased in length as a counteracting measure in that respect, the machine would then become unnecessarily bulky and expensive.

GB patent No 1 308 074 which forms the most relevant state of the art and which the present invention takes as its basic starting point discloses a cosmetic pencil in which the lead is formed from elongate filaments which are oriented along the longitudinal axis of the lead and which adhere to each other. The lead constructed in that way forms a capillary reservoir in which the cosmetic liquid to be applied is stored. There is a gap between the lead and a housing enclosing the lead. At one end of the housing it is provided with points which project into the interior of the housing and which engage into the fiber lead and thus spatially fix the lead in position.

The object of the present invention is to propose a cosmetic pencil and a process for the production thereof, of the kind set forth in the opening part of this specification, which prevent flexing of the lead upon insertion into the sleeve body or in use of the cosmetic pencil so that touching contact between the lead and a portion of the sleeve body is prevented.

In regard to the cosmetic pencil the foregoing object is attained by the features of claim 1. Following appendant claims 2 through 19 15 set forth further advantageous embodiments in relation thereto.

### SUMMARY OF THE INVENTION

The foregoing object is attained by providing a cosmetic pencil comprising a sleeve body which in its interior has a longitudinally extending cavity which is open outwardly by way of at least one opening and a lead of a cosmetic material, which is arranged in the cavity, wherein the lead is arranged in the sleeve body at least portion-wise in spaced relationship in the peripheral and/or longitudinal direction with respect to the inside wall of the cavity of the sleeve body, forming an empty space, and wherein there is also provided a fixing securing means for the lead in the cavity of the sleeve body, which fixes the lead in the interior of the cavity at least to prevent rotation thereof, characterised in that arranged at the inside wall of the cavity are a plurality of guide ribs which extend in the longitudinal direction of the cavity and which are arranged in mutually spaced relationship in the peripheral direction thereof and which are in line contact at least portion-wise with the outside surface of the lead and that the sleeve body is made from a transparent material.

The solution, to the above-discussed technical problem means that leads can be produced from a cosmetic material in a conventional molding process or an equally known extrusion process and the lead produced in that way can then be introduced in a separate working step into a sleeve body comprising a transparent material in such a way that in that case the inside wall of the cavity in the sleeve body is not touched by the material at least in part, for example in the region of the transparent portions. In that case the sleeve body can be produced in known manner by extrusion of a suitable plastic material and cutting the extrusion to length, or by injection molding processes which are also known.

In that respect it is not absolutely necessary to adopt a round cross-section for the lead of cosmetic material. The lead can certainly also be of a cross-section which is different from round, in the form of a polygon or an oval. In that case, or also in other cases, the lead is to be reliably fixed to prevent it from rotating during the sharpening operation and/or from slipping out, preferably at its end of the sleeve body, which is in opposite relationship to the lead tip. Fixing in the front or central region of the sleeve body is however basically also possible. For that purpose a fixing securing means is provided for the lead in the cavity of the sleeve body, which fixes the lead in the interior of the cavity at least to prevent it from rotating.

In order now to prevent bending of the lead of cosmetic material when the lead is introduced into the sleeve body or in use of the cosmetic pencil, it is also possible to arrange at the inside wall of the cavity a plurality of guide ribs which extend in the longitudinal direction of the cavity and which are in contact with the outside surface of the lead at at least portion-wise. That can reliably avoid touching contact between the lead and the transparent portion of the sleeve body. In addition, the plurality of guide ribs can be arranged in the peripheral direction of the inside wall of the cavity in such a way that the ribs can preferably be at an equal spacing relative to each other in the peripheral direction.

In that case insertion of the lead can be effected both from the front end of the sleeve body and also from the rear end.

As the sleeve body is predominantly or completely transparent then the lead can be arranged spaced from the inside wall of the cavity, forming an empty space, predominantly or completely, in the peripheral and longitudinal direction. That can be achieved if the inside diameter of the cavity is slightly larger than the outside diameter of the inserted lead. As already stated above, it is essential that in that case the inside wall of the cavity is not touched. Preferably the lead is arranged in concentric relationship with the longitudinal center line of the cavity, in spaced relationship with the inside wall of the cavity, forming the empty space. It is particularly advantageous in that respect if the annular gap which is formed in that case is of a magnitude of between 0.03 and 0.30 mm.

The fixing securing means can be of quite different structures. Thus on the one hand there is the possibility of the fixing securing means being formed by clamping of the lead in the interior of the cavity of the sleeve body. For that purpose, it is possible to provide at the one end of the cosmetic pencil, at least one slot which extends in the longitudinal direction of the cosmetic pencil and which can be compressed by means of a clamping element fitted on to the end of the cosmetic pencil, with a reduction in the inside diameter of the hollow space of the sleeve body.

In addition the fixing securing means can be formed by a fused-on portion of the lead in the interior of the cavity of the sleeve body, in which case the lead is anchored in recessed portions and the like, which can be disposed in the end region at the inside wall of the cavity of the sleeve body. The lead end fusing operation can be effected either from the exterior by means of high-energy radiation, for example by ultrasound or by microwaves, which however in the case of a sleeve body of plastic material can result in adverse changes in the plastic material and is less preferred for that reason. The simplest procedure therefore is to effect brief heating by the introduction of a sufficiently heated body such as for example a metal body which is heated electrically (or in some other fashion).

In addition, the fixing securing means can be formed by a wax plug introduced into the one end of the sleeve body. That wax plug, for which it is also possible to provide a melt adhesive which preferably remains at least partially elastic after cooling, can come into engagement with tooth configurations provided at the inside wall of the cavity and/or the lead, in the form of for example undercut portions, grooves, a screwthread, ribs and so forth, and can thus fix the lead. A further possible design option for the fixing securing means provides that it is formed by at least one shaped portion which on the one hand is fitted into the lead and which on the other hand comes into engagement with co-operating elements provided at the inside of the cavity of the sleeve body. In that arrangement the co-operating elements can be formed by the same configurations as have been described hereinbefore in connection with the wax plug.

Finally the fixing securing means can be formed by a displacement body which is mounted to an insert portion, for example in the form of an end stopper, and which penetrates into the lead upon insertion of the insert portion.

The rear end of the cosmetic pencil according to the invention can preferably be closed by an inserted closure cap or a closure cap which is fitted over the end portion of the sleeve body, which is prepared for that purpose, while the application tip of the lead is provided with a removable cover cap, a so-called protector cap. The protector cap is intended to prevent damage to and soiling of the application tip.

If the leads used contain volatile constituents such as for example volatile silicone oils or isoparaffins, then the closure cap and the cover cap or the protector cap must be so designed that they securely seal off the sleeve when not in use. The closure cap and the protector cap can comprise any materials and can likewise be transparent or colored with the same color as the lead or ‘CI-true’. In that respect, a sealing means for sealing off the cavity in gas-tight and/or liquid-tight relationship can be provided between the cover cap and/or the closure cap on the one hand and the sleeve body on the other hand.

In particular the process according to the invention for the production of a cosmetic pencil includes the following steps: providing a sleeve body which in its interior has a longitudinally extending cavity which is open outwardly by way of at least one opening, providing a lead produced by molding or extrusion, dimensioning the outside diameter of the lead in such a way that it is at least slightly smaller than the inside diameter of the cavity in the sleeve body, and introducing the lead into the cavity in the sleeve body, and introducing the lead into the cavity in the sleeve body, wherein provided at the inside wall of the cavity are a plurality of guide ribs which extend in the longitudinal direction of the cavity and which are arranged in mutually spaced relationship in the peripheral direction thereof and which are in line contact at least portion-wise with the outside surface of the lead, and a transparent material is selected for the sleeve body.

In order to facilitate the lead-introduction procedure and/or to avoid damage to the lead at the outside thereof when it is pushed into position by virtue of lead material temporarily adhering to the inside wall of the cavity of the sleeve body, in particular in the regions in which the lead is not at a spacing relative to the inside wall of the cavity, it is further advantageous if a friction-reducing means, preferably talc, is applied to the outside of the lead at least in portion-wise manner, at least slightly. In that case the friction-reducing means is applied in particular to the portions of the lead which possibly are not at a spacing relative to the inside wall of the cavity.

### BRIEF DESCRIPTION OF THE DRAWINGS

Further advantageous configurations and embodiments by way of example of the invention are described hereinafter by means of the description in conjunction with the accompanying drawings. In this connection it is to be pointed out that the terms used in the description of the specific embodiments ‘left’, ‘right’, ‘top’ and ‘bottom’ refer to the drawings with the Figure identifications and references being readable normally. In addition it is pointed out that functionally and/or geometrically identical components are identified in the drawings by the same references. In the drawings:

FIG. 1 is a view half in section of a first embodiment by way of example of a cosmetic pencil to explain the invention shown in FIGS. 4 through 6,

FIG. 2 is a view in longitudinal section on an enlarged scale in comparison with FIG. 1, showing the rear portion of the cosmetic pencil illustrated in FIG. 1,

FIG. 3 is a view in longitudinal section on an enlarged scale in comparison with FIG. 1 showing the rear portion of a further embodiment of the cosmetic pencil shown in FIG. 1,

FIG. 3a shows a cross-sectional view taken along line III-III in FIG. 3,

FIG. 4 is a view in longitudinal section on an enlarged scale in comparison with FIG. 1 showing the rear portion of a first embodiment of the invention,

FIG. 4a shows a cross-sectional view taken along line IV-IV in FIG. 4,

FIG. 5 is a view in longitudinal section on an enlarged scale in comparison with FIG. 1 showing the rear portion of a second embodiment of the invention, and

FIG. 6 is a view in longitudinal section on an enlarged scale in comparison with FIG. 1 showing the rear portion of a third embodiment of the invention.

### DETAILED DESCRIPTION

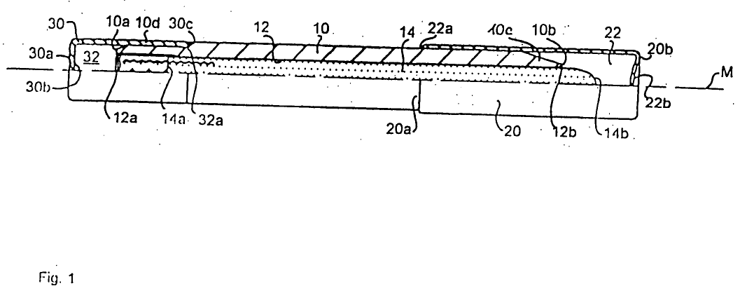

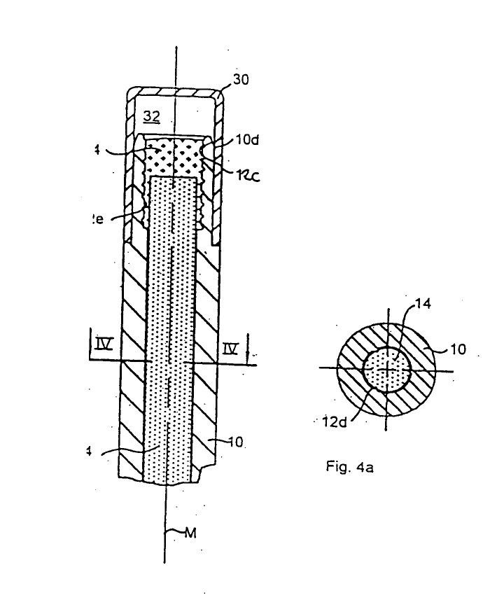

A cosmetic pencil as shown in FIG. 1, which is described for better understanding of the cosmetic pencils according to the invention, shown in connection with FIGS. 4 through 6, firstly comprises an elongate sleeve body 10 which is made from a transparent plastic material which is suitable for cutting machining and has a left-hand and a right-hand end 10a, 10b. In the region of its right-hand end 10b the sleeve body 10 is provided with a chamfer 10c which can be produced by cutting machining of the sleeve body 10.

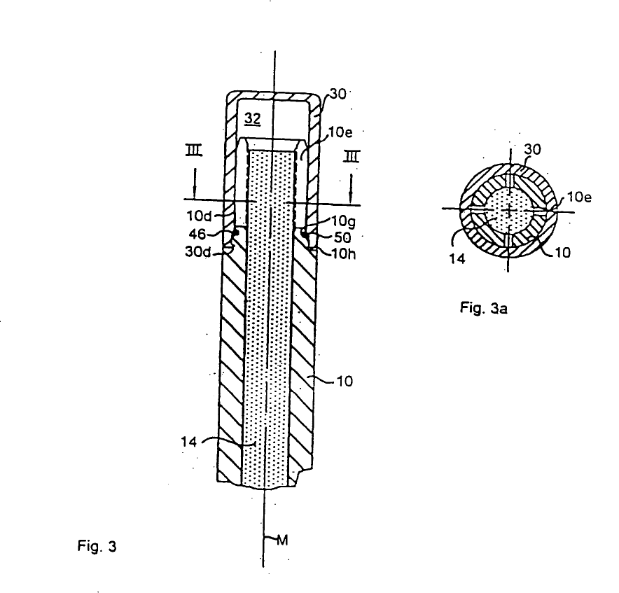

In its interior the sleeve body 10 has a continuous cavity 12 which extends therethrough and which is arranged in coaxial relationship with its longitudinal center line M and which has a respective opening 12a, 12b outwardly at the ends 10a, 10b of the sleeve body 10. Both the outside contour of the sleeve body 10 and also the cavity 12 are of a circular shape as viewed in cross-section (see for example FIG. 3a).

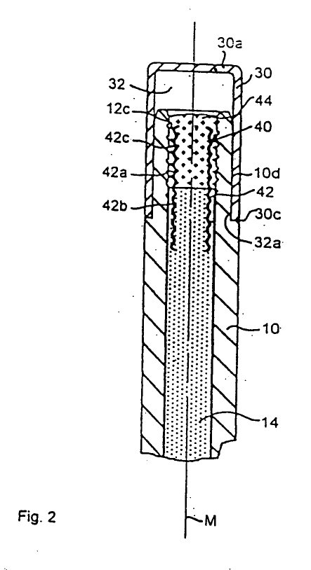

A rod-shaped stick or lead 14 of a cosmetic material is arranged in the interior of the cavity 12 in coaxial relationship with the longitudinal center line M of the sleeve body 10. At the right end 10b of the sleeve body 10 the lead 14 projects beyond the opening 12b, whereas in the region of the left end 10a of the sleeve body 10 it is at a spacing relative to the opening 12a at that location. The lead 14 is of an outside diameter which is slightly smaller than the inside diameter of the cavity 12 so that, upon being inserted into the cavity 12 of the cosmetic pencil, it is firstly freely movable therein and an empty space in the form of an annular gap is afforded between the outside peripheral surface of the lead 14 and the inside wall of the cavity 12. Axial fixing of the lead 14 and the fixing thereof in the peripheral direction is described hereinafter with reference to FIG. 2. It is also to be noted that the left end 14a of the rod 14 of material extends at an angle of 90° relative to the longitudinal center line M of the sleeve body 10 whereas, at its right end 14b, it is in the form of a convexly rounded tip which is also referred to as the application tip.

As further components, the cosmetic pencil as shown in FIG. 1, has a cylindrical, slightly conical or frustoconical cover cap 20 which can be reversibly fitted on to the sleeve body 10 to cover the right ends 10b, 14b of the sleeve body 10 and the lead 14. For that purpose the cover cap 20 which is made from the same plastic material or a different plastic material from the material of the sleeve body 10 has a cavity 22 which is of an inside diameter which is slightly larger than the outside diameter of the sleeve body 10 and which is open outwardly by way of an opening 22a at the left-hand end 20a of the cover cap 20. At the right-hand end 20b of the cover cap 20 it is provided with a concavely inwardly curving end portion 22b. When the cover cap 20 is fitted on to the sleeve body 10, the cover cap 20 is so positioned with respect to the sleeve body 10 that there is a spacing between the left-hand end 14b of the lead 14 and the end portion 22b of the cover cap 20, so that the end 14b of the lead 14, which is shaped to provide the convexly rounded tip, is not damaged by the cover cap 20 being fitted on. A gas-tight and/or liquid-tight seal (not shown) can possibly also be provided between the sleeve body 10 and the cover cap 20. In addition, locking elements (not shown) can also be provided between the cover cap 20 and the sleeve body 10, for releasably locking the cover cap 20 to the sleeve body 10. Alternatively the inside diameter of the cover cap 20 and the outside diameter of the sleeve body 10 can be so matched to each other that there is a tight push fit between them.

In the region of the left-hand end 10a which can have a bevel which is only slight in relation to the bevel 10c at the right-hand end 10b of the sleeve body 10 and which is possibly also provided at the inside wall of the cavity 12, a cylindrical or slightly conical or frustoconical closure cap 30 is fitted on the sleeve body 10. The closure cap 30 can be connected to the sleeve body 10 non-releasably, for example by glueing or welding, or by positively locking latching engagement, and it can be made from the same material or a different material from the material of the sleeve body 10, such as for example metal or another plastic material. At the left-hand end 30a the closure cap 30 is provided with an integrally formed end portion 30b which extends substantially perpendicularly to the longitudinal center line M of the sleeve body 10. The closure cap 30 in turn has a cavity 32 which is open outwardly by way of an opening 32a at the right-hand end 30c of the closure cap 30 and which, when the closure cap 30 is fitted on to the sleeve body 10, holds the end portion 30b spaced from the left-hand end 10a of the sleeve body 10. In contrast to the cover cap 20 the outside peripheral surface of the closure cap 30 is aligned with the outside peripheral surface of the sleeve body 10. For that purpose the sleeve body 10 has a peripherally extending recess 10d which extends from the left-hand end 10a towards the right and the radial depth of which is such that it is at least approximately identical to the wall thickness of the closure cap 30. It is also to be noted that a gas-tight and/or liquid-tight seal (not shown) can possibly also be provided between the sleeve body 10 and the cover cap 20 (see in that respect also FIG. 3).

FIG. 2 shows the fixing securing means 40 which is operative to prevent axial displacement and rotation in the peripheral direction and which can also be used in the cosmetic pencils according to the invention, which are described hereinafter with reference to FIGS. 4 through 6. It is firstly formed by a sleeve-shaped portion 42 which is open at both ends and which has a thin wall gauge and the outside wall 42a of which is corrugated in a direction parallel to the longitudinal center line M of the sleeve body 10 or has beads or ribs. There is also the possibility that the shaped portion 42 can have apertures, for example in a form similar to a wire mesh fence, which can also be combined with the beads, ribs or the corrugation configuration. That shaped portion 42 which can be of a cross-section differing from a circular cross-section is fitted into the lead 14 approximately as far as its axial center. In this case, the outside diameter of the shaped portion 42 is such that it is slightly smaller than the outside diameter of the lead 14 so that the lower portion 42b of the shaped portion 42, which is the lower portion in FIG. 2 and is inserted into the lead 14, is completely surrounded by the material of the lead 14. The portion 42c of the shaped portion 42, which projects out of the left-hand end 14a of the lead 14, being the upper end in FIG. 2, is enclosed by a wax plug 44 which extends from the left-hand or upper end 14a of the lead 14 at least approximately to the left-hand end 10a of the sleeve body 10, being the upper end in FIG. 2. So that the wax plug 44, for which it is also possible to provide a melt adhesive which preferably remains at least partially elastic after cooling, can be securely connected to the sleeve body 10, the inside wall of the cavity 12, in the region of the peripherally extending recess 10d, has a tooth configuration or grooving 12c which also extends at least partially in peripheral relationship and to which the wax plug 44 is ‘meshed’ when it hardens. The grooving 12c can also be formed by annular grooves or a screwthread which is cut into the inside wall of the cavity 12.

The cosmetic pencil according to the invention as shown in FIGS. 1 and 2 is produced as follows:

Firstly the sleeve body 10 is produced by means of a known production process. Independently thereof, at the same time or before same or after same, the lead 14 can be produced by means of a known extruding or molding process. The shaped portion 42 can then be fitted into the left-hand or upper end 14a of the lead 14. When the lead 14 is produced by molding, the shaped portion 42 can be inserted during the molding operation. If in contrast the lead 42 is produced by an extrusion operation, then for inserting the shaped portion 42 the lead 14 must be softened in the region of the end portion of the lead 14 by the application of heat so that the shaped portion 42 can be pushed into the softened end portion. After the lead 14 is cooled, as is possibly necessary, to ambient temperature or a temperature below ambient temperature, the lead 14 is pushed into the cavity 12 by way of the opening 12b. As a consequence of the fact that the outside diameter of the lead 14 is slightly less than the inside diameter of the cavity 12, the lead 14 does not touch the wall of the cavity 12 so that the disadvantages discussed in the opening part of this specification, particularly when dealing with a transparent sleeve body 10, do not occur. Thereupon the mass of wax necessary for forming the wax plug 44 can be cast into the cavity 12 by way of the opening 12a of the cavity 12. After solidification of the wax plug 44 or immediately after the mass of wax has been poured in, the closure cap 30 can be pushed on to the recess 10d of the sleeve body 10 until the right-hand end 30c, being the lower end in FIG. 2, bears against the step (not identified) of the sleeve body 10 and is then fixed in the above-indicated manner to the sleeve body 10. Finally, the cover cap 20 can also be fitted on to the sleeve body 10, in which respect it is to be noted that this can also already be effected immediately after the step of pushing the lead 14 into the cavity 12 of the hollow body 10.

FIGS. 3 through 6 shows a further embodiment by way of example of the cosmetic pencil shown in FIG. 1, which is described hereinafter for better understanding of the cosmetic pencils according to the invention which are shown in FIGS. 4 through 6. For the avoidance of repetition, only the differences between this embodiment and the first embodiment described with reference to FIGS. 1 and 2 will now be discussed.

The second embodiment shown in FIGS. 3 and 3a, of the cosmetic pencil as shown in FIG. 1 differs from the first embodiment in the fixing securing means 30 which can also be used in the cosmetic pencils according to the invention, which are described hereinafter with reference to FIGS. 4 through 6. In this case, in the region of the peripherally extending recess 10d, the sleeve body 10 has four slots 10e which are spaced relative to each other in the peripheral direction through an angle of 90° and which extend parallel to the longitudinal center line M of the sleeve body 10. As can be seen from FIG. 3, the slots 10e extend in an identical manner from the left-hand or upper end 10a of the sleeve body 10 to just before the axial end of the peripherally extending recess 10d. As a consequence of the reduction in wall thickness due to the slots 10e and the peripherally extending recess 10d, that region of the sleeve body 10 is ‘flexurally soft’ or elastically deformable. That elastic deformability is used to fix the lead 14 which in this embodiment extends to just before the left-hand or upper end 10a of the sleeve body, in the axial direction and in the peripheral direction, by clamping it fast. That is achieved by the closure cap 30, upon being fitted on to the peripherally extending recess 10d, compressing the end region of the sleeve body 10, that is defined by the slots 10e. That compression effect provides that the grooving 12c which is also provided on the inside wall of the cavity 12 digs in this region into the outside periphery of the lead 14 and thus fixes it in position both in the axial direction and also in the peripheral direction.

In addition, in the region of the inwardly disposed ends of the slots 10e, the sleeve body 10 has a thickening (not further identified) into which are incorporated two axially mutually spaced annular grooves 10g, 10h. The annular groove 10g which is closer to the left-hand or upper end 10a of the sleeve body 10 serves to receive an elastic sealing ring 50. A radially inwardly facing annular projection 30d integrally formed at the opening 32a of the closure cap 30 engages into the axially further inwardly disposed annular groove 10h, whereby the closure cap 30 is locked to the sleeve body 10. At the region in axially adjoining relationship with the annular projection 30d the closure cap 30 is of a configuration corresponding to the thickening on the sleeve body 10, as a co-operating sealing surface for forming the sealing integrity with the sealing ring 50.

It is also to be noted that basically it is also possible for the sealing ring 50 to be replaced by a small amount of an elastic melt adhesive. In that case either the melt adhesive must be sprayed on as a peripherally extending line in the hot condition or some drops are sprayed on from several sides and then, after being fitted in place, the closure cap 30 is turned through some degrees in order to distribute the adhesive. Alternatively, the adhesive can be injected into the closure cap 30 and the closure cap 30 is only then fitted on to the sleeve body 10.

FIGS. 4 and 4a show a first embodiment of the cosmetic pencil according to the invention. It firstly differs from the embodiment of a cosmetic pencil shown in FIGS. 1 and 2 for better understanding of the invention, in that three guide ribs 12d which are in mutually spaced relationship through 120° in the peripheral direction are integrally formed on the inside wall of the cavity 12. Those guide ribs 12d which guide and hold the lead 14 in its axial position with respect to the longitudinal center line M of the sleeve body 10 extend from the right-hand or lower end 10b of the hollow body 10 approximately into the region of the peripherally extending recess 10d. As can be seen from FIG. 4a the guide ribs 12d are of a triangular configuration in cross-section, wherein a point of the triangle faces towards the lead 14. With that point, the guide ribs 12d are in contact with the outside peripheral surface of the lead 14 or penetrate slightly into the material of the lead 14.

In comparison with the cosmetic pencils for explaining the invention, as shown in FIGS. 1 through 3a, the cavity 12 of the first embodiment of the invention has an also peripherally extending diametral enlargement 12e in the region of the peripherally extending recess 10d at the inside wall of the cavity 12. As can be seen from FIG. 4 the diametral enlargement 12e extends from the left-hand or upper end 10a of the sleeve body 10 into the cavity 12, but it is of an axial length which is shorter than that of the peripherally extending recess 10d. Grooving 12c is again provided in the region of the diametral enlargement 12e.

As can also be seen from FIG. 4 the lead 14 partially projects into the diametral enlargement 12e, preferably approximately as far as the axial center of the diametral enlargement 12e. The diametral enlargement 12e of the cavity 12 makes it possible that the wax material provided for the wax plug 44 is not only present at the left-hand or upper end 14e of the lead 14, but can at least approximately completely enclose the lead 14 as far as the inward end of the diametral enlargement 12e. When the wax material hardens it again ‘meshes’ with the grooving 12c and therefore fixes the lead 14 in position in the peripheral and longitudinal direction.

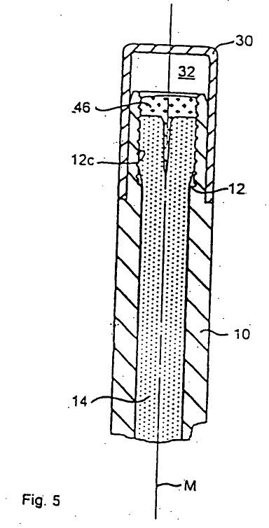

The second embodiment shown in FIG. 5 of a cosmetic pencil according to the invention differs from the first embodiment shown in FIGS. 4 and 4a insofar as, instead of the wax plug 44, an end stopper 46 is inserted into the left-hand or upper end 10a of the sleeve body 10. The end stopper 46 has a centrally arranged and wedge-shaped displacement element 46a integrally formed thereon. When the end stopper 46 is inserted into the cavity 12 of the hollow body 10 that displacement element 46 penetrates into the material of the lead 14 and divides it, as shown in FIG. 5. As a result, the end portion (not identified) of the lead 14 is urged annularly outwardly and comes into engagement with the grooving 12c. That process can be still further assisted by at least the displacement element 46 being heated prior to insertion of the end stopper 46 into the cavity 12. The pressure force exerted when the end stopper 46 is inserted means that the end plug 46 is also expanded in the radial direction and therefore also comes into engagement with the grooving 12c. In that way the lead 14 is fixed in position generally both in the peripheral direction and also in the longitudinal direction.

It is also to be noted that the end stopper 46 can be of such a configuration that it seals the cavity 12. In addition the end stopper 46 together with the displacement element 46a can be integrally formed on the end portion 30b of the closure cap 30. Alternatively there is also the possibility that a part which does not belong to the finished cosmetic pencil and which for example can be a component part of the production apparatus and which is provided with a wedge-shaped point can be pushed into the sleeve body and into the lead which is positioned therein in its final position. In that case, the end of the lead is expanded and urged in anchoring relationship into the beads or ribs or screwthread portions in the end part of the sleeve body 10. After removal of that component, the gap which remains in the lead 14 can then be filled with a wax, a melt adhesive or the like.

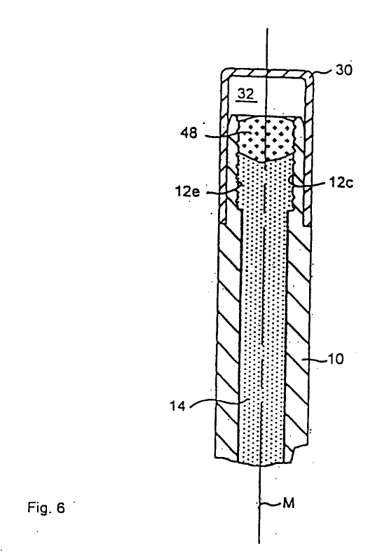

The third embodiment of the cosmetic pencil according to the invention, which is shown in FIG. 6 and which is suitable in particular for ‘slim pencils’ with a relatively thin lead 14 differs from the second embodiment shown in FIG. 5 insofar as, after being inserted into the cavity 12, the lead 14 is melted in the region of the diametral enlargement 12e, whereby lead material ‘meshes’ with the beads, ribs or screwthread portions provided in the region of the peripherally extending recess 12d in the inside wall of the cavity 12. The cavity which is produced in that case is closed (sealed) by means of the wax plug 44. The operation of melting the end of the lead in the embodiment illustrated in FIG. 6 can either be effected from the exterior by means of high-energy radiation, for example by an ultrasound source or by microwaves, which however when dealing with a sleeve body of plastic material can lead to adverse changes in the plastic material and is therefore less preferred. The simplest procedure therefore is to provide for short-term heating by introducing a sufficiently heated body such as for example a metal body which is heated electrically (or otherwise). A corresponding consideration also applies for the embodiment shown in FIG. 5.

The above-discussed cosmetic pencils according to the invention in principle have a sleeve body 10 of circular-cylindrical configuration as round cylindrical bodies are easy to seal off, which is of particular interest when the leads 14 contain volatile constituents. As however in principle the technology involved in also hermetically sealing off hollow bodies 10 which are different from round is already properly mastered, any way of designing the exterior of a cosmetic pencil is open to the designer. Any shape in terms of cross-section is therefore conceivable, from triangular by way of an increased number of angles to any conceivable polygon. An oval cross-section is also possible. Embodiments which are star-shaped in cross-section are somewhat more difficult to seal off but in principle can also be adopted. It is thus also conceivable for the internal cross-section of the sleeve body 10 to be of a shape which differs from round. Furthermore it is also possible that the cavity does not have walls in parallel relationship with the axis, but is of a spiral or ball-like configuration (in the manner of a ball-form cooler).

Finally it is to be noted that the sleeve body 10 which can be produced by an injection molding process can be in the form of two oppositely arranged truncated cones. The lead 14 can equally possibly also be produced in the form of a cone in a molding process and it can be inserted with its thinner end into the enlarged end of the truncated cone configuration of the sleeve body 10. In principle the lead 14 can also be inserted into the sleeve body 10 from the left-hand or upper end 10a thereof, but then in the above-outlined case care is to be taken to ensure that the tip formed on the lead 14 is not placed in the left-hand or upper end 10a of the sleeve body 10.

1-30. (canceled)

31. A cosmetic pencil comprising a sleeve body (10) which in its interior has a longitudinally extending cavity (12) which is open outwardly by way of at least one opening (12a, 12b) and a lead (14) of a cosmetic material, which is arranged in the cavity (12), wherein the lead (14) is arranged in the sleeve body (10) at least portion-wise in spaced relationship in the peripheral and/or longitudinal direction with respect to the inside wall of the cavity (12) of the sleeve body (10), forming an empty space, and wherein there is also provided a fixing securing means (40) for the lead (14) in the cavity (12) of the sleeve body (10), which fixes the lead (14) in the interior of the cavity (12) at least to prevent rotation thereof,
characterised in that arranged at the inside wall of the cavity (12) are a plurality of guide ribs (12d) which extend in the longitudinal direction of the cavity (12) and which are arranged in mutually spaced relationship in the peripheral direction thereof and which are in line contact at least portion-wise with the outside surface of the lead (14) and that the sleeve body (10) is made from a transparent material.

32. A cosmetic pencil as set forth in claim 31, wherein the lead (14) is spaced at least almost completely relative to the inside wall of the cavity (12), forming the empty space.

33. A cosmetic pencil as set forth in claim 32, wherein the lead (14) is arranged in concentric relationship with respect to the longitudinal center line (M) of the cavity (12) spaced in relation to the inside wall of the cavity (12), forming the empty space.

34. A cosmetic pencil as set forth in claim 31, wherein the fixing securing means (40) is provided in the region of the one end of the sleeve body (10).

35. A cosmetic pencil as set forth in claim 31, wherein the fixing securing means (40) is formed by a clamping means (10e, 30) for the lead (14) in the interior of the cavity (12) of the sleeve body (10).

36. A cosmetic pencil as set forth in claim 35, wherein provided at the one end of the sleeve body (10) is at least one slot (10e) which extends in the longitudinal direction of the sleeve body and which is compressible by means of a clamping element (30) fitted on to the end of the sleeve body (10), with a reduction in the inside diameter of the cavity (12) of the sleeve body (10).

37. A cosmetic pencil as set forth in claim 31, wherein the fixing securing means (40) is formed by a melted portion of the lead (14) in the interior of the cavity (12) of the sleeve body (10).

38. A cosmetic pencil as set forth in claim 31, wherein the fixing securing means (40) is formed by a wax plug (44) introduced into the one end of the sleeve body (10).

39. A cosmetic pencil as set forth in claim 31, wherein the fixing securing means (40) is formed by at least one shaped portion (42) which on the one hand is inserted into the lead (14) and which on the other hand comes into engagement with co-operating elements (12c) provided at the inside of the cavity (12) of the sleeve body (10).

40. A cosmetic pencil as set forth in claim 31, wherein the fixing securing means (40) is formed by a displacement body (46a) which is disposed on an insert portion (46) which penetrates into the lead (14) upon insertion of the insert portion (46).

41. A cosmetic pencil as set forth in claim 31, wherein the opening (12a, 12b) of the sleeve body (10) is closable by a cap (20, 30).

42. A cosmetic pencil as set forth in claim 41, wherein a sealing means (50) is provided between the cap (20, 30) and the cavity (12) of the sleeve body (10).

43. A cosmetic pencil as set forth in claim 42, wherein the sleeve body (10) is of a cross-section differing from a circular cross-section.

44. A cosmetic pencil as set forth in claim 42, wherein the sleeve body (10) is made from a material which can be sharpened to a point.

45. A cosmetic pencil as set forth in claim 31, wherein the lead (14) is of a cross-section which differs from a circular cross-section.

46. A process for producing a cosmetic pencil as set forth in one claim 31, wherein the process includes the following steps:
providing a sleeve body which in its interior has a longitudinally extending cavity which is open outwardly by way of at least one opening,
providing a lead produced by molding or extrusion,
dimensioning the outside diameter of the lead in such a way that it is at least slightly smaller than the inside diameter of the cavity of the sleeve body,
introducing the lead into the cavity of the sleeve body,
fixing the lead in the interior of the cavity of the pencil body by means of a fixing securing means,
characterised in provided at the inside wall of the cavity are a plurality of guide ribs which extend in the longitudinal direction of the cavity and which are arranged in mutually spaced relationship in the peripheral direction thereof and which are in line contact at least portion-wise with the outside surface of the lead, and a transparent material is selected for the sleeve body.

47. A process as set forth in claim 46, wherein the fixing is effected by melting a portion of the lead.

48. A process as set forth in claim 47, wherein the melting operation is effected by ultrasound.

49. A process as set forth in claim 47, wherein the melting operation is effected by applying microwaves to the lead.

50. A process as set forth in claim 47, wherein the melting operation is effected by heating the lead.

51. A process as set forth in claim 47, wherein the lead is fixed in the cavity of the sleeve body by a wax plug.

52. A process as set forth in claim 47, wherein the lead is fixed by inserting a shaped portion into an end region of the lead in such a way that the shaped portion can come into engagement with engagement elements provided at the inside wall of the cavity.

53. A process as set forth in claim 47, wherein the lead is fixed by being clamped fast by means of deformation of the sleeve body.

54. A process as set forth in claim 46, wherein the opening in the sleeve body is sealed off.

55. A process as set forth in claim 46, wherein a friction-reducing means is applied to the outside of the lead prior to the insertion thereof into the sleeve body.

56. A process as set forth in claim 55, wherein the friction-reducing means is applied to the portions of the lead, which have no spacing relative to the inside wall of the cavity.
